(19) United States
(12) Patent Application Publication
(10) Pub. No.: US 2022/0307804 A1
(43) Pub. Date: Sep. 29, 2022

(54) TRAINER MANNEQUIN AND METHOD OF MANUFACTURING A TRAINER MANNEQUIN

(71) Applicant: NOA Brands America, Inc., Lafayette, CO (US)

(72) Inventors: Scott AMMAN, Thornton, CO (US); Peter FITZSIMMONS, Frederick, CO (US)

(73) Assignee: NOA Brands America, Inc., Lafayette, CO (US)

(21) Appl. No.: 17/610,009

(22) PCT Filed: Apr. 16, 2020
(86) PCT No.: PCT/US2020/028429

§ 371 Date: Nov. 9, 2021

Related U.S. Application Data
(60) Provisional application No. 62/838,755, filed on Apr. 25, 2019.

(51) Int. Cl. F41J 1/10; F41J 2/02

(52) U.S. Cl. CPC F41J 1/10; F41J 2/02; G09B 23/32

(57) ABSTRACT

The present disclosure describes mannequins providing realistic human forms to train personnel in organizations such as police departments, fire departments, the military, paramilitary organizations, private military contractors, etc. Mannequins may serve as targets or may be forms useful for various search or search and rescue operations. One aspect of the present disclosure may describe a manufacturing process for a mannequin designed to serve as a target for non-lethal ammunition or live. A cold rotational molding process may be used to manufacture such a mannequin. A mannequin may emulate one or more physical characteristics of a live human. In one embodiment of a present disclosure, a mannequin may include a thermal heating system radiating thermal energy from within a mannequin and may be configured such that the exterior of the mannequin emits thermal energy like that of a live human in both distribution through the body and intensity.

### CROSS-REFERENCE TO RELATED APPLICATION

This application claims priority to U.S. Provisional Patent Application No. 62/838,755, which was filed on Apr. 25, 2019. The entirety of U.S. Provisional Patent Application No. 62/838,755 is hereby incorporated by reference.

### TECHNICAL FIELD

The present disclosure relates to mannequins. More specifically, aspects of the present disclosure may relate to mannequins suitable for use as tactical mannequins or targets in training exercises using non-lethal ammunition or live ammunition.

### BACKGROUND

Police forces, military personnel, and other similar organizations often do live training exercises several times per year and routinely employ forms (known as mannequins or dummies) as part of these exercises, namely by shooting such forms with projectiles and other non-lethal ammunition or live ammunition.

Conventional mannequins typically employed in retail settings are not durable enough to withstand being hit with non-lethal ammunition without puncturing or cracking. In addition, such mannequins are typically painted. Surface paint on retail mannequins is highly susceptible to chipping when hit by non-lethal ammunition or live ammunition. As a result, it would be advantageous to have a mannequin that resists punctures or cracking when hit with non-lethal ammunition and live ammunition and without paint chipping off when being hit with a target.

There may be a commercial need for mannequins that may be used as targets for non-lethal ammunition (e.g., rubber bullets, bean bags, simunition, pepperballs, rubber batons, and tasers), capable of withstanding being hit with such non-lethal ammunition without puncturing or paint chipping. There may also be a need for mannequins that may be used as targets for live ammunition, accurately modeling a three-dimensional human form while capable of withstanding more live rounds than currently available mannequins or dummies. There may be a further need for mannequins used to train law enforcement, SWAT, military personnel, fire departments, and the like. Such personnel may use advanced weaponry or search tools, and there may be a need for mannequins capable of simulating physical, human characteristics. The present disclosure may address the foregoing aspects and others, as may be apparent to a person of ordinary skill in the art.

### BRIEF SUMMARY OF THE DISCLOSURE

The present disclosure describes three-dimensional (“3D”) mannequins providing realistic human forms and parts thereof to train personnel in organizations such as police departments, fire departments, the military, paramilitary organizations, private military contractors, and the like. Mannequins according to one or more aspects of the present disclosure may serve as targets or may be forms useful for various search or search and rescue operations.

One aspect of the present disclosure may describe a manufacturing process for a mannequin designed to serve as a target for non-lethal ammunition. Another aspect of the present disclosure may describe a manufacturing process for a mannequin designed to serve as a target for live ammunition. In an embodiment of the present disclosure, a cold rotational molding process may be used to manufacture such a mannequin.

One aspect of the present disclosure may describe a mannequin that emulates one or more physical characteristics of a live human. In one embodiment of a present disclosure, a mannequin may include a thermal heating system. A thermal heating system may radiate thermal energy from within a mannequin and may be configured such that the exterior of the mannequin emits thermal energy like that of a live human. In an embodiment, a thermal heating system may match the thermal emissions of a live human in both distribution through the body and intensity.

### BRIEF DESCRIPTION OF THE DRAWINGS

The foregoing and other features of the present disclosure may become more fully apparent from the following description, taken in conjunction with the accompanying drawings. Understanding that these drawings depict only several embodiments in according with the disclosure and are, therefore, not to be considered limiting of its scope, the disclosure will be described with additional specificity and detail through use of, and example reference to, the drawings.

In the drawings:

FIG. 1 is a front view of a mannequin according to an aspect of the present disclosure.

FIG. 2 is a side view of a mannequin according to an aspect of the present disclosure.

FIG. 3 is a side view of a mannequin according to an aspect of the present disclosure.

FIG. 4 is a side view of a mannequin according to an aspect of the present disclosure.

FIG. 5 is a front view of a mannequin according to an aspect of the present disclosure.

FIG. 6 is a side view of a mannequin according to an aspect of the present disclosure.

FIG. 7 is a front view of a mannequin according to an aspect of the present disclosure.

FIG. 8 is a front view of a mannequin according to an aspect of the present disclosure.

FIG. 9 is a side view of a mannequin according to an aspect of the present disclosure.

FIG. 10 shows wiring extending through a shell of a mannequin and electrically coupling a power source to one or more electrical components in the interior of a mannequin according to an aspect of the present disclosure.

FIG. 11 illustrates a long pin connection that may be used to adjustably attach a mannequin appendage to a mannequin torso according to an aspect of the present disclosure.

FIG. 12 illustrates an example thermal heating system according to an embodiment of the present disclosure.

FIG. 13 illustrates a partially exploded view of a mannequin torso, an electrical connection, a thermal heating system, a post-mount bracket, and a post according to an aspect of the present disclosure.

FIG. 14 illustrates the bottom of a torso of a mannequin to which a post-mount bracket has been affixed according to an aspect of the present disclosure.

FIG. 15 illustrates the bottom of a torso of a mannequin to which a post-mount bracket is attached and screws for making the attachment according to an aspect of the present disclosure.

FIG. 16 illustrates an example electrical connection coupling a power source to one or more electrical components disposed in the interior of a mannequin according to an aspect of the present disclosure.

FIG. 17 illustrates an example electrical connection coupling a power source to one or more electrical components disposed in the interior of a mannequin according to an aspect of the present disclosure.

FIG. 18 illustrates an example electrical cable strain relief component that may be used in one or more embodiments according to the present disclosure.

FIG. 19 illustrates an example electrical converter allowing one or more electrical components disposed in the interior of a mannequin to be electrically coupled to a wall outlet.

FIG. 20 is a perspective view of an example of a thermal heating system according to an aspect of the present disclosure.

FIG. 21 is a perspective view of an example of a thermal heating system according to an aspect of the present disclosure.

FIG. 22 is a perspective view of an example of a thermal heating system according to an aspect of the present disclosure.

FIG. 23 is a perspective view of an example of a thermal heating system according to an aspect of the present disclosure.

FIG. 24 is a perspective view of an example of a thermal heating system according to an aspect of the present disclosure.

FIG. 25 is a perspective view of an example of a thermal heating system according to an aspect of the present disclosure.

FIG. 26 is a perspective view of an example of a thermal heating system according to an aspect of the present disclosure.

FIG. 27 is a top view of an example of a thermal heating system according to an aspect of the present disclosure.

FIG. 28 is a side view of an example of a thermal heating system according to an aspect of the present disclosure.

### DETAILED DESCRIPTION OF THE DISCLOSURE

In the following detailed description, reference is made to the accompanying drawings, which form a part of the description. In the drawings, similar symbols identify similar components, unless the context dictates otherwise. The illustrative embodiments described in the detailed description and drawings are not meant to be limiting. Other embodiments may be utilized, and other changes may be made, without departing from the spirit or scope of the subject matter presented herein. It will be readily understood that aspects of the present disclosure, as described herein and illustrated in the drawings, may be arranged, substituted, combined, and designed in a wide variety of different configurations, all of which are explicitly contemplated and make part of this disclosure.

The present disclosure is generally drawn to methods and apparatus related to mannequins in various applications. More specifically, in one or more aspects of the present disclosure, three-dimensional mannequins (including full human forms and human body parts) may be configured to train first responders (e.g., police and fire), military personnel, members of paramilitary organizations, military contractors, and the like. Members of police and fire departments, the military, paramilitary organizations, and military contractors may find a target sized and three-dimensionally shaped to mimic a human advantageous. Such personnel may also find a human-sized and human-shaped target capable of withstanding rounds from training ammunition, non-lethal ammunition, and, in an embodiment, live ammunition, advantageous. Moreover, a human-sized and human-shaped target having adjustable and re-positionable features (e.g., arms and legs) to, for example, simulate an attacker may be advantageous. Additionally, a mannequin may include one or more features designed to simulate human characteristics. In an embodiment, a mannequin may emit thermal energy such that the mannequin has a thermal signature that approximates the thermal signature of a live human. In an embodiment, a mannequin emitting thermal energy may be detectable using certain instruments designed to detect heat, such as thermal scopes or other tactical imaging devices.

The present disclosure also presents an example manufacturing process to produce a mannequin having an exterior shell capable of withstanding training rounds, such as non-lethal ammunition. The present disclosure may also describe a manufacturing process to produce a mannequin having an exterior shell more likely to withstand live ammunition than existing mannequins. Such a manufacturing process may include a two-stage molding process, and at least one of the stages may include a cold rotational molding process. In an aspect of the present disclosure, a mannequin may include an outer shell that is relatively thicker than a conventional (e.g., retail) mannequin.

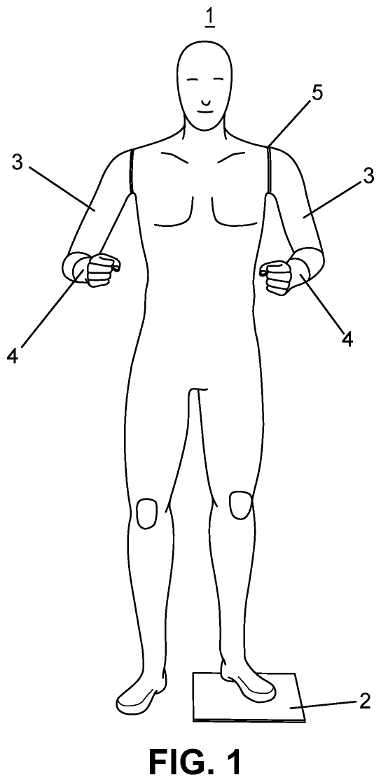

FIG. 1 illustrates an example mannequin 1 according to at least one aspect of the present disclosure. Mannequin 1 may be disposed on a stand 2 to stabilize the mannequin 1 in an upright position. In an embodiment, stand 2 may include a pole configured to extend into a portion of mannequin 1 (e.g., a leg or foot). Mannequin 1 may include attachable and adjustable appendages 3, such as arms, which may be repositioned to simulate various positions. When appendage 3 is an arm, the arm may further include additional adjustable portions, such as an adjustable wrist and hand 4. In an embodiment, mannequin 1 may be positioned into a position simulating an aggressor. According to an aspect of the present disclosure, the shell of mannequin 1 may comprise a polyurethane. In an embodiment, the polyurethane may be optimized to maximize the durability of the shell of mannequin 1 to allow the shell to withstand repeated impacts from training ammunition.

Mannequin 1 may include a shoulder plate 5 on the torso portion where appendage 3 may be attached or adjusted. A shoulder plate 5 may include multiple pinholes, allowing a corresponding pin in appendage 3 to engage and set the appendage 3 in a particular position. With multiple pinholes, appendage 3 may be adjusted or rotated. A hip joint may be similarly configured, allowing adjustment of legs. An adjustable wrist and hand 4 may be similarly configured with respect to appendage 3. This adjustability may lead to more realistic and more varied training scenarios.

In an embodiment, one or more joints on the mannequin 1 (e.g., a shoulder joint) may include a stretch joint. A stretch joint may allow first and second mannequin 1 parts (e.g., an appendage 3 and a torso part) to move relative to each other. A stretch joint may be designed so that after opening (e.g., when one part joined at a stretch joint experiences a force), the parts joined at the stretch joint will automatically close when the force subsides. A stretch joint may be designed such that the two joined parts will close in the original closed position.

A detachable leg comprising a stretch joint hereof can be easily pulled toward the other leg in order to dress the mannequin in a pair of pants, and therefore does not need to be detached and reattached for this purpose. In the context of a tactical or target mannequin, a stretch joint may allow the mannequin 1 or a part thereof (such as appendage 3) to be hit by training or non-lethal ammunition, experience a force from the ammunition, allow the part of the mannequin to move relative to the other joined part (thereby absorbing some or all of the force), then automatically close the joined parts back to the original position. In an embodiment, the joint parts might not rotate with respect to each other in a direction parallel to the joint interface. In an embodiment, a locking key might not rotate out of a locked position with respect to the keyway in use, so that there is no worry that the joint will accidentally disengage after repeatedly being partially opened. In an embodiment, a limb engaged in a stretch joint can be rotated in two directions, e.g., sideways and back and forth or up and down. In an embodiment, a limb forming part of a stretch join can be attached in a desired position and will not rotate out of this position when the joint is partially opened and then closed, as the limb automatically repositions itself correctly when the joint is closed.

A stretch joint may connect first and second mannequin parts, and when said first and second parts are connected, capable of allowing the joint to partially open by pivoting the joined parts with respect to each other on a pivot point on the interface between the joined parts. The stretch joint may comprise: a first joint assembly attached to the first mannequin part; a second joint assembly attached to the second mannequin part, the second joint assembly being capable of detachably engaging with the first joint assembly. The second joint assembly may comprise a stretch element, which in use may be attached to the first mannequin part at a first attachment point on the stretch element and to the second mannequin part at a second attachment point on the stretch element. In use the stretch element may be capable of being elongated by applying a first stretching force to it at the second attachment point or at a point on the stretch element other than the first attachment point. The stretch element may also be capable of automatically returning to a less elongated position when the stretching force subsides.

The joint may also include a pivot element operationally connected to the stretch element, allowing said stretch element to pivot in a primary rotational direction, wherein the mannequin parts in use may pivot with respect to each other at a pivot point located at an interface between the first and second mannequin parts into a partially-open position in which the joint interfaces can form an angle with respect to each other greater than about 15°, or in other embodiments, between about 20° and about 60°, such as 30° or more, 40° or more 45° or more, or 50° or more. A greater angle that is allowed may allow a joined mannequin part to absorb more impact force without being destroyed, for example, by training ammunition or non-lethal ammunition.

A rigid element may extend between the joined parts and may prevent them from sliding with respect to each other when the joint is in partially open position.

An example of a stretch joint used in retail mannequins is found in U.S. Pat. No. 9,398,820, the disclosure of which is herein incorporated by reference. A stretch joint for a tactical mannequin, or a mannequin used as a target for ammunition, may be modified to optimize the absorbance of, and ability to withstand, forces imparted by trainer ammunition or non-lethal ammunition.

As an example, appendage 3 for use in a stretch joint may be molded with a longer than conventional center location pin or keybody. Additionally or alternatively, appendage 3 may also be molded with a magnet. A longer-than-conventional pin or keybody may keep the arms on the mannequin better when being hit with rounds, but may still allow rotation to different positions. In an embodiment, an arm molded with a magnet, and/or in a stretch joint, may be able to deflect or rotate when hit to absorb the force of the impact, then “swing” or rotate back to the original position. In an embodiment, this so-called long pin 20 may have a length between 1.9 and 2.0 inches (such as about 1.95 inches). FIG. 11 illustrates a sectional view an example long pin 20 (sectioned axially). In an embodiment, the long pin 20 may have one or more circular cross-sections when sectioned radially. In an embodiment, a long pin 20 may be staggered to have cross-sections of differing or increasing diameters across the length of the long pin 20. In an embodiment, a long pin 20 may include three sections 21, 22, 23, each section having a circular cross-section having a different diameter. In such an embodiment, the first cross section diameter 21 may be about 0.25 inches, the second cross section diameter 22 may be about 0.375 inches, and the third cross section diameter 23 may be about 0.5 inches. In an embodiment, the section 23 of the long pin 20 having the largest cross sectional diameter may be about 1 inch long and each of the other two sections 21, 22 may be between about 0.40 and 0.50 inches long.

As an alternative to a stretch joint, one mannequin part may be joined to another mannequin part through a magnetic coupling. A mannequin mannequins can include removable pieces attached to each other by a magnetic system comprising a magnetic assembly having a depth-of-pull sufficient to cause the removable piece to seek home, i.e., begin to move toward the attracted material, at a distance of at least one inch or, in other embodiments, a distance greater than one-half inch, e.g., a distance of about three-fourths inches. In one embodiment, this depth of pull is about 120 gauss at one inch, more preferably it is greater than about 200 gauss at one inch and, most preferably, is about 240 gauss at one inch. Said magnetic assembly may be positioned on said mannequin or said removable piece. Said magnetic system also comprises an attracted material on the other of said form or said removable piece so as to mate with said magnetic assembly.

The removable piece may be any portion of the mannequin, and is preferably selected from the group consisting of an arm, an upper arm, a lower arm, a hand, a leg, an upper leg, a lower leg, a foot, a hand, a head, a torso, and a pelvis.

The attracted material may be steel, iron, or other magnetically-adherent material known to the art and may be positioned on the other of the removable piece or the main body of the mannequin and designed to mate with a corresponding magnetic assembly. Magnetic assemblies and attracted materials may also be placed on either or both ends of magnetic limbs, so that portions of limbs may be attached to each other, e.g. hands to lower arms to upper arms. A given detachable piece may comprise one or more structures made of attracted material, one or more magnetic assemblies, one of each, or any combination thereof as required to assemble the complete mannequin.

The attracted material is preferably a piece of metal, preferably a steel disc having a thickness of at least about one-eighth inch. A thinner material will result in a less strong magnetic bond. Thicker pieces may be used but may result in a heavier and more costly joint. The depth-of-pull of the magnetic assembly is the amount of force exerted by the magnetic material at a point a given distance from the magnetic assembly. In different embodiments, the magnetic assembly has a depth of pull of at least about 160 gauss or at least about 170 gauss at a distance of one inch. Preferably, the magnetic assembly has a depth-of pull of at least about 200 gauss at one inch, and more preferably a depth-of-pull of about 240 gauss at one inch. The depth-of-pull is preferably no greater than about 250 gauss at one inch to avoid pinching the operator's fingers by having the magnetic assembly engage with the attached material too quickly and strongly.

In addition to its depth-of-pull, the magnetic assembly will also have an on-contact contact strength, which is the amount of force required to separate the magnetic assembly from direct contact with the attracted material. Preferably, for joining an adult-size arm to a mannequin, the magnetic assembly has an on-contact strength of at least about 60-120 pounds, more preferably at least about 85 pounds, and most preferably, at least about 100 pounds. The on-contact strength is preferably no greater than about 120 pounds. Preferably, for joining a child size arm to a mannequin, the magnetic assembly has an on-contact strength of at least about 20-60 pounds, more preferably at least about 30 pounds, and most preferably, at least about 35 pounds. For a shoulder cap, used to cover the shoulder joint when no arm is required for the mannequin, the on-contact strength is preferably no more than about 20 pounds. The amount of on-contact strength required should be sufficient to hold the limb in place and prevent it from easily being knocked off during normal use and not so great as to prevent manual disengagement of the limb by the operator.

As used herein, depth-of-pull is defined in terms of gauss readings at various distances from the magnetic material measured in air, in the absence of an attracted material.

A greater or lesser amount of magnetic material may be used in a larger or smaller magnetic assembly designed to fit infant wrist joints, adult arms, legs, heads, or other parts with differently-sized cross-sections to provide the required depth-of-pull. Preferably, the magnetic assembly is arranged as described herein for the preferred embodiment, scaled up or down as appropriate. However, other materials and configurations may be used, as will be appreciated by those skilled in the art.

The cup design is especially useful for adapting to various joint sizes since its on-contact strength can be varied, e.g., from around 0.5 pounds up to 180 pounds with selection of appropriate magnetic materials.

The magnetic material and configuration of the magnetic assembly to provide appropriate on-contact strengths will be readily ascertainable by those skilled in the art without undue experimentation in accordance with principles dis cussed herein and known to the art.

The mannequins according to one or more aspects of the present disclosure, if having magnetically attachable parts, may have the following advantages: If the mannequin is knocked over, if someone pulls on the attached part, or if the attached part is hit with non-lethal ammunition or live ammunition, it generally will come loose rather than breaking off, and the mating parts are self-seeking in use, so that they will come together in proper orientation even when being mated beneath clothes. The self-seeking feature of the magnetic mating parts of this invention substantially aids in ease of setting up or resetting a mannequin and provides significant time savings.

In a preferred embodiment hereof, a cup magnetic assembly comprising a circular cup which serves as a pole piece is provided. It is believed that the cup shape focuses the magnetic energy toward the front (top edge of the cup), minimizing leakage of magnetic force. The cup need not be circular; it can also be square, rectangular, oval, polygonal, or other shapes. A magnetic material within the cup provides the magnetic force. Many magnetic materials are known to the art including strontium ferrite ceramic magnets, neodymium and samarium cobalt. To optimize performance and cost, combinations of known magnetic materials may be used, e.g., combinations of lower power magnets such as strontium ferrite ceramic, ferrite with higher power magnets such as neodymium or strontium cobalt, or either type with arnico or other medium power magnet.

The cup assembly allows the magnetic field to be forced to the outer edges of the cup to take full advantage of the magnets being used.

A magnet seated within the cup, such as a ring magnet e.g. a ceramic magnet such as a strontium ferrite ring having relatively less depth-of-pull, preferably not in contact with the sides of the cup, may be used to provide on-contact strength for the magnet. As will be apparent to those skilled in the art, other types of magnetic materials, or combinations thereof, may also be used. The shape of the magnetic material may be varied; however, the magnetic material should not extend to the top of the cup, since if it is in direct contact with the attracted material, either some of the magnetic force will be lost or the on-contact strength could be increased to unacceptable levels, depending on orientation of the poles of the magnetic material. Alternately, a non-magnetically adherent material can be used to prevent direct contact between the magnetic material and the attracted material (e.g. an austenitic stainless steel lid placed on the magnetic assembly to cover the magnets), in which case the magnetic material need not be below the top of the cup. In an embodiment where the magnetic material does not extend to the top of the cup involving a cup-shaped pole piece having a diameter of two and a half inches and a height of one-half inch, there is a gap of about 0.15 inch between the magnetic material and the top of the cup.

In order to provide more depth-of-pull, additional magnetic material having a strong depth-of-pull in contact with the ring magnet but separated from direct contact with the pole piece (outer edges of the cup) may be provided. Because the size of the mannequin joint is limited, the size of the magnetic assembly will be limited, and it will usually be necessary to conserve space within the cup-shaped pole piece. Using nothing but strontium ferrite ceramic magnets in the preferred embodiment of this invention might require a pole piece too large to fit within the typical mannequin joint. Thus, additional magnetic materials to provide depth-of-pull are preferably made of materials which provide greater depth-of-pull than the ceramic magnets. Neodymium magnets are preferred, e.g., neodymium-iron-boron materials. They may be in the form of a ring, radial arc segments, or any other desirable shape, so long as the separation from the sides of the pole piece is maintained and the desired depth of-pull is achieved. In a preferred embodiment, the magnetic assembly comprises as additional magnetic material—two neodymium arc segments symmetrically placed opposite each other, and spanning about 45-90 degrees of arc in the ring magnet. The size of such additional magnetic materials is selected to provide the required depth-of-pull as will be evident to those of skill in the art, or easily ascertainable without undue experimentation using the information provided herein. The additional magnetic materials are spaced apart from the pole piece (outer edges of the cup) a sufficient distance so that the magnetic force therefrom is not substantially conducted through the pole piece. Preferably, the additional magnetic materials are spaced apart from the pole piece at least about one-eighth inch in the preferred embodiment hereof which involves the use of a circular cup-shaped pole piece having a height of one-half inch and a diameter of two and a half inches.

The magnetic assemblies and attracted materials may be sized to accommodate the joints being attached. For example, smaller versions might be used at the wrists and ankles. The proportion of materials having a stronger magnetism to mass ratio could be increased to allow for a stronger magnetic bond using the smaller size.

Methods for attaching removable pieces of mannequins are also provided herein comprising aligning the pieces to be attached and allowing them to be held in place by magnetic force, or placing the magnetic attachment systems in approximate alignment, and allowing magnetic force to complete the mating. Approximate alignment means that the components (the magnetic assembly and attracted material) are close enough together that the strength of the magnetic field at that distance (the depth-of-pull) is sufficient to pull the parts together. Specifically, the magnetic pull should be felt when the components are placed at least about one inch apart. It is often desirable that the distance between the removable piece and the mannequin be greater than about one-half inch, and preferably greater than about two-thirds or three fourths of an inch when sufficient pull is present to allow the pieces to “seek home”. Greater precision than these distances is difficult to achieve when the operator is attempting to align the parts “blind,” i.e. under clothing.

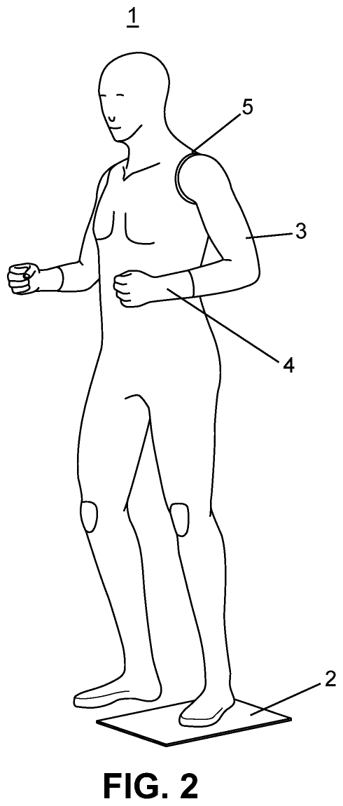

FIGS. 2-9 illustrate additional examples of mannequin 1 and may have some or all of the features described with respect to FIG. 1.

FIG. 2 illustrates a side view of a mannequin 1. In FIG. 2, the three-dimensional nature of mannequin 1 and human size and human shape may be more fully appreciated. When mannequin 1 is used as a target for training with non-lethal tools, such as rubber bullets, bean bags, simunition, pepperballs, rubber batons, and tasers, mannequin 1 may provide a more accurate target and, thus, a better and more realistic training experience.

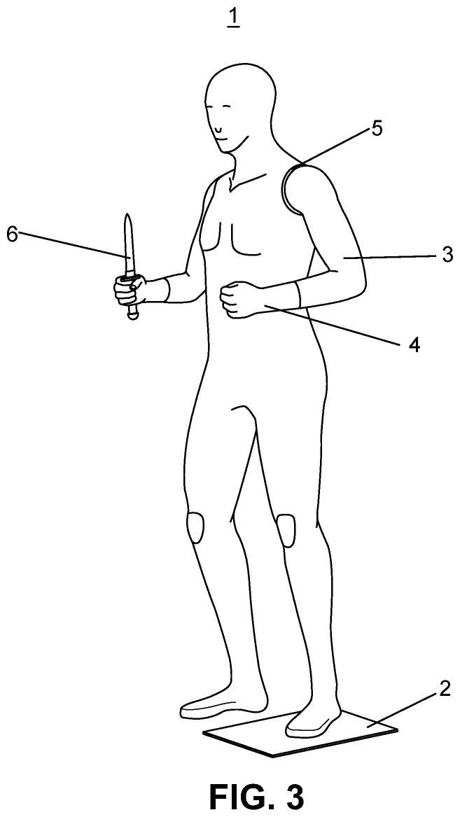

FIG. 3 illustrates a side view of mannequin 1. In an embodiment, an adjustable wrist and hand 4 may be adjusted to grip a weapon 6, such as a knife, gun, or striking object like a bat or pipe. Having adjustable mannequin parts such as adjustable wrist and hand 4 allows mannequin 1 to brandish a weapon 6 and makes the mannequin 1 more threatening and aggressive. Incorporating a weapon 6 may further vary the training scenarios that may be offered through use of mannequin 1.

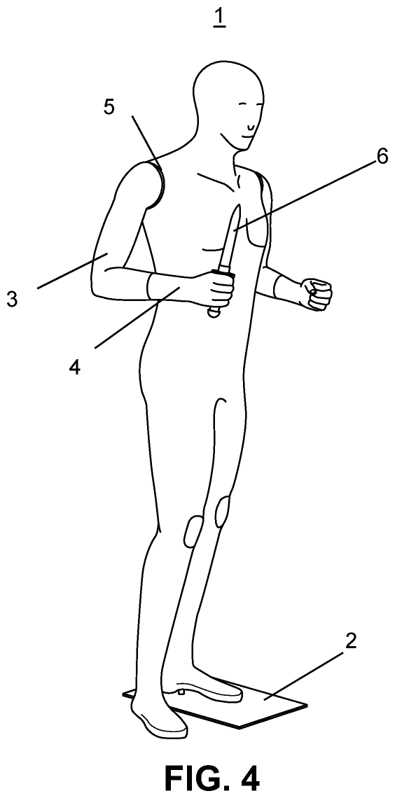

FIG. 4 illustrates another side view of mannequin 1. In the example of FIG. 4, mannequin 1 is brandishing a weapon 6, and appendages 3 and adjustable wrists and hands 4 are adjusted to be in a realistic, aggressive posture.

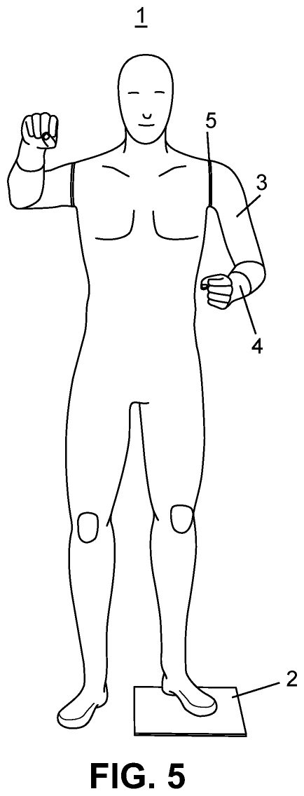

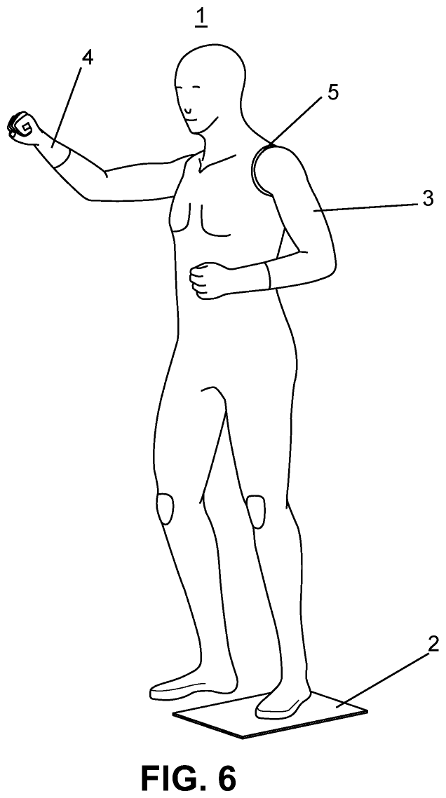

FIG. 5 is a front view of a mannequin 1. Relative to FIGS. 1-4, one of the appendages 3 and one of the adjustable wrists and hands 4 have been adjusted to place mannequin 1 in a different position. As described, other parts of the mannequin may be similarly adjustable, such as a leg joined at the torso at a hip joint. Such a hip joint may include a stretch joint. In such an embodiment, the mannequin 1 could be placed in a running position. FIG. 6 illustrates a side view of mannequin 1 positioned as in FIG. 5.

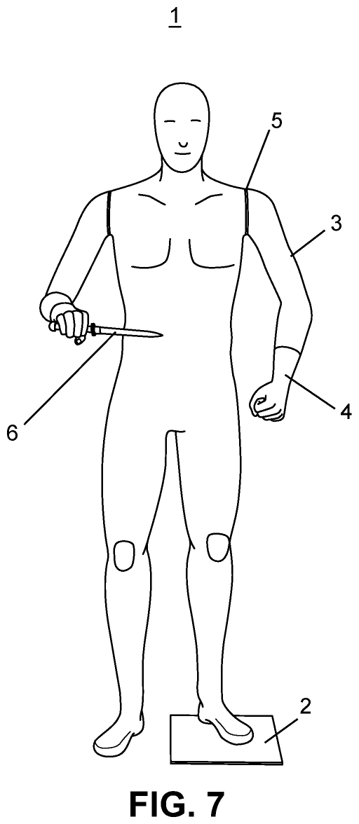

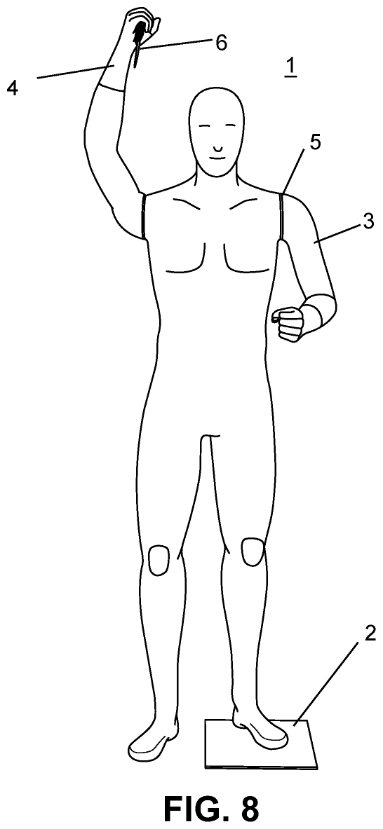

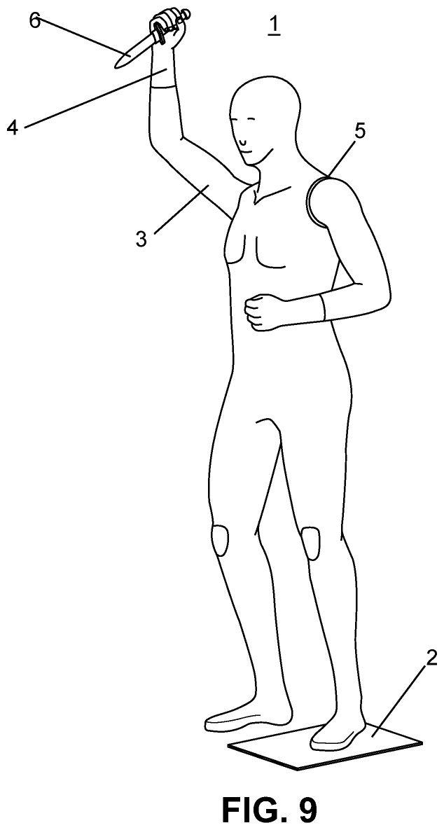

FIG. 7 illustrates a front view of mannequin 1 in yet another position. The mannequin in FIG. 7 is brandishing a weapon 6. FIG. 8 illustrates a mannequin 1 whose appendages 3 have been adjusted to place the mannequin 1 in an even more aggressive position. Mannequin 1 in FIG. 8 looks as if it is about to strike someone with weapon 6. In the embodiment of FIG. 8, weapon 6 is a knife, and the mannequin 1 has been placed in a position to simulate an attacker about to stab a victim. FIG. 9 shows a side view of the mannequin 1 positioned as in FIG. 8. The various positions illustrated in FIGS. 1-9 show a mannequin 1 in various stages of aggression, which may have significance in a training exercise (e.g., at which point use of force is authorized). For example, it may be ill advised or contrary to the rules of engagement to shoot a mannequin positioned as in FIG. 1, but it may be recommended to shoot a mannequin positioned as in FIGS. 8-9.

In an embodiment, mannequin 1 and parts thereof may be formed through a cold rotational molding process. In an embodiment, an outer shell of mannequin 1 may comprise one or more polyurethanes. In an embodiment, a cold rotational molding process may involve coating a mold in polyurethane resin, then, before the resin completely sets and cures (e.g., while the resin has formed its shape but is still tacky), a second addition of polyurethane resin may be added to the mold. The polyurethane in the second addition may comprise the same or different ingredients as the first addition of polyurethane. In an embodiment, both the first and second additions of polyurethane may form a hard shell. In an embodiment, when the first and second additions of polyurethane have set, a mannequin shell having a thick outer shell may be formed. Such a thicker outer shell may make such a mannequin more puncture resistant, particularly against simulation or trainer ammunition and non-lethal ammunition. Additionally or alternatively, a mannequin formed in such a manner may be resistant to deformation at elevated temperatures, which may be significant if, for example, a mannequin is positioned to simulate a fire victim in a search and rescue exercise.

Adjustable mannequins 1, and parts thereof, as shown in FIGS. 1-9, may be so formed.

In an embodiment, mannequin 1, or a part thereof, may be produced according to the following process. The mannequin or mannequin parts may be made in a two-stage cold rotational molding process using two additions (also called “shots”) of polyurethane. In an embodiment, the polyurethane may be the same polyurethane in both shots. First, the total amount of polyurethane may be calculated (e.g., by volume of liquid material, by weight, etc.). The amount required may vary depending on the size of the mannequin or mannequin part and desired finished thickness. Second, the total amount of material may be divided into the two shots. In an embodiment, the first shot may comprise about 45% by weight of the total amount of polyurethane, with the remaining about 55% in the second shot. While the amount of material in each respective shot may be varied, as would be understood by a person of ordinary skill in the art, having too much material in the first shot may cause blockages in the mold and may prevent even coverage of the mold by the first shot. In another embodiment, the first shot may comprise about 40% by weight of the total calculated amount of polyurethane, and the second shot may include about 60% by weight of the total calculated amount of polyurethane. In another embodiment, the two shots may be evenly split. In another embodiment, material may be added in more than two shots, which may enable still a thicker shell while assuring even coating of the mold and preventing blockages.

In an embodiment, after the material is divided into shots, the first shot may be added to the mold. Next, a specific pre-rotation process may be executed, ensuring that the polyurethane of the first shot covers the entire mold before setting. In an embodiment, the pre-rotation process may last about 30 seconds. Then, the mold may rotate for about five and a half more minutes. Then, the second shot of polyurethane may be added. The material added in the first shot may have set but may still be not completely cured. In such a state, the material of the first shot may still be tacky, ensuring good adhesion of the material of the second shot to the material of the first shot and making separation between the material of the first and second shots unlikely. After the second shot is added, a pre-rotation process may be executed to assure even coating of the second shot. After the pre-rotation process (e.g., about thirty more seconds), the tool may be rocked and rolled in a rotation process. In an embodiment, this rotation process may continue for about another 33.5 minutes, yielding a total of about 40 minutes from the time the first shot was added, before demolding.

In an embodiment, the amount of material may be calculated to yield a mannequin 1 or a part thereof having a shell thickness of about ¼″ to about ⅜″. In such an embodiment, mannequin 1 may have sufficient structural support and impact resistance from non-lethal ammunition or training ammunition.

In an embodiment, through additional shots or larger shots, a mannequin having a thicker shell may be manufactured if desired, which would increase the weight of the mannequin but may make the mannequin more durable.

In an embodiment, both the first shot and the second shot of polyurethane may be the same material. In an embodiment, the polyurethane may comprise a ratio of between about 70:100 isocyanate:polyol to about 100:82 isocyanate:polyol by volume of the components. In an alternate embodiment, the polyurethane may comprise a ratio of about 801:1000 isocyanate:polyol by volume of the components.

In an embodiment, mannequins made according to one or more aspects of the present disclosure may be more resistant to deformation under temperatures up to 170, or 180 or 185° F. There is no need for a metal armature inside the mannequin to provide support for the outer walls. The molded articles may be made by a process of cold rotational molding (rather than a melted thermoplastic or thermosetting rotational molding process), at or around room temperature.

The method may performed at a temperature within the mold sufficient to maintain the first and second polymer mix at viscosities low enough to form and set into coatings, but not too low to prevent the mix from flowing well enough to coat the inner surface of the mold. Typically this temperature will be between about 105 and about 115° F.

In an embodiment, the uncured polymer mixes comprise polyurethane, which may have as components polyol or polyester resin, isocyanate, and a curing catalyst. The uncured polymer mixes can also comprise pigments or dyes effective to produce a desired color for the shell. In embodiments, the first mix, for the polymer shell, has an isocyanate to polyol ratio of about 77:100. In an alternate embodiment, the polymer shell (including either one or both of the first shell and/or the second shell) includes an isocyanate to polyol ration of about 801:1000 by volume of the components. In an embodiment, a mannequin may further include a foam backing manufactured as a third shot, and the foam backing, may have an isocyanate to polyol ratio of about 100:82 to about 100:92, and in a specific embodiment, 100:87 by volume of the components. The isocyanate to polyol ratio is selected so as to provide a reaction that produces a desirable flow time as further described below. The slower the reaction, the longer the period during which the mix will stay liquid enough to flow. The isocyanate to polyol ratio, along with the polymer components and other system parameters are selected so as to produce the desired amount of foam and/or shell in the desired amount of time.

In embodiments, neither the mold nor the molded article comprise an internal armature, i.e., a support structure. Many conventional mannequins require internal armatures made of metal or other strong, rigid material, to support the mannequin in an upright position. This adds to the weight of the mannequin. An advantage of the present method is that it allows the making of mannequins and other molded articles that do not require such armatures.

After molding, a mannequin may require only sanding or deflashing with little or no other preparation or paint work being necessary or applied. The mannequins can be produced with only an orange—or any other color—safety tint. Alternatively, the mannequins may be produced with a skin-tone tint. Alternatively, a mannequin may be produced with a tint designed to camouflage the mannequin, rendering visual detection more difficult, which may be advantageous in a training scenario designed to detect a mannequin by a method not involving visual detection, such as through thermal or auditory detection, as may be described later. Thus, the need to finish and paint the mannequins is reduced or eliminated. By adding a tint along with a neutral urethane, when a mannequin is hit with a target, the coloring may not chip off as occurs with conventionally painted mannequins. Alternatively, a mannequin may be produced without tint.

Mannequins according to one or more aspects of the present disclosure may allow for dynamic, real-world training at many angles or positions. A mannequin may be sized to approximate the height, width, and dimensional characteristics of a human (such as, but not limited to, an adult male), and weights may be added to approximate the mass or center of gravity of a human. As an example, a mannequin may possess the scale and massing of an adult male having height of 73″, allowing a trainee to target center mass and extremities. Alternatively, mannequins may be sized to have different heights. As an example, a mannequin may be constructed to weigh 45 pounds, so the mannequin may be easily portable, requiring no tools, equipment, or counterweights. Alternatively, a mannequin may be weighted, and weights may be distributed to give the mannequin a realistic center of gravity. Such a feature may allow trainees to observe how the mannequin reacts to an impact, which may translate to a more realistic training experience compared to a two-dimensional (e.g., paper) target, an immobile target or a three-dimensional target (e.g., a dummy) fixedly attached to a floor, ceiling, or wall. Alternatively, if desired, a mannequin may be attached to a surface, such as a floor or wall. Attaching means such as nails, screws, bolts, threaded mating connectors, adhesive, snaps, plugs, tongue-and-groove systems, hook-and-loop connectors, and more may be used to affix a mannequin to a surface, and a mannequin may include one or more connection means (such as a threaded hole, or a pin, for example).

In an embodiment, a mannequin may have a height of about 73″, a chest circumference of about 42″, a waist circumference of about 35″, a hip circumference of about 41″, and an inseam of about 32″.

In an embodiment, a mannequin according to one or more aspects of the present disclosure may comprise a polyurethane shell having a durometer measurement of between about 62 to about 67.

A mannequin may be made according to alternate processes. In an embodiment, an aerosol truck-bed liner may be applied to the inside of a mold, and the mold may be rocked and rolled. Alternatively, a mannequin made by cold rotational molding as described above may be additionally coated in a truck-bed liner.

In an embodiment, a mannequin may include a thermal heating system. In one aspect of this embodiment, a thermal heating system may be designed or configured to heat a mannequin from the interior of the mannequin, such that the exterior of the mannequin emits or radiates thermal energy. A thermal heating system may be designed or configured such that the mannequin emits or radiates thermal energy in the same manner, or approximating the thermal signature, of a live human.

In an embodiment, a thermal heating system may provide heat to the mannequin such that heat radiates from the outer shell of the mannequin, thereby simulating thermal characteristics of a human. In one embodiment, a thermal heating system may include a heating unit, a power source, connectors for connecting the heating unit and power source, and one or more mounting bracket. Alternatively or additionally, a thermal heating system may include a fan, which may help to distribute thermal energy more evenly throughout the mannequin. In an embodiment, the heating unit may include a 12-volt, 150-watt compact heater. In an embodiment, the power source may include a compatible source of electrical energy; in the 12-volt heater embodiment, the power source may be a 12-volt battery (e.g., a car battery, a lithium ion battery, or any other source of energy).

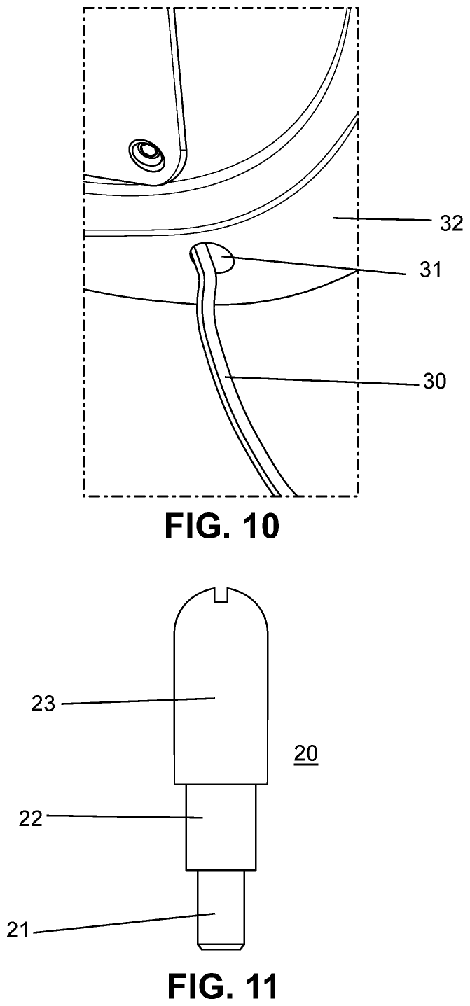

In an embodiment, a power source for a thermal heating system may be a wall outlet. Electrical connectors supplying power to one or more components of a thermal heating system may be routed through a hole in the shell of a mannequin. FIG. 10 shows an example of such a configuration, with electrical wiring 30 being routed through a hole 31 in the shell 32 of a mannequin. In an embodiment, shell 32 may comprise polyurethane. In an embodiment, wiring 30 may connect via a standard two-prong connector leading to additional wiring, which in turn may be plugged into a wall outlet.

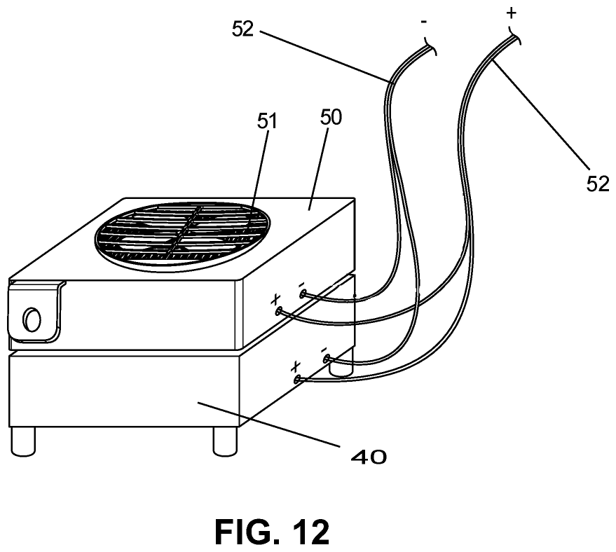

FIG. 12 illustrates an example fan and heater combination for use in an example thermal heating system, with associated wiring. In an embodiment, a fan 40 may draw air up and force air through a heater 50. Heater 50 may include heating coils 51. In an embodiment, fan 40 may be a 12-volt fan, and heater 50 may be a 12-volt, 100-150 watt heater. Electrical wiring 52 may lead to a two-prong electrical connector outside of a mannequin shell, which in turn may be connected to a power source, such as a battery or a wall outlet.

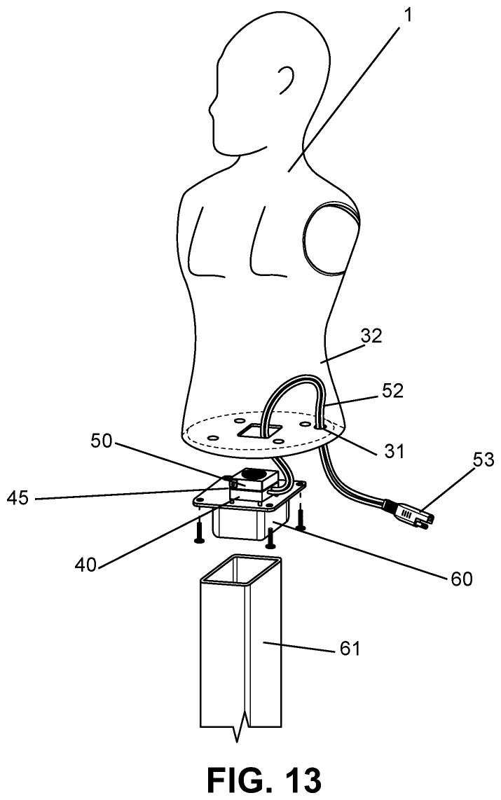

FIG. 13 illustrates one embodiment according to one or more aspects of the present disclosure. In the embodiment of FIG. 13, a bust of a mannequin 1 (which includes a torso and head section of a mannequin 1) is provided without appendages 3, though a person of ordinary skill in the art would understand that appendages 3 could be provided. FIG. 13 is a partially exploded view showing the bust of mannequin 1 with a thermal heating system 45, which comprises a fan 40, heater 50, and electrical wiring 52, a post-mount bracket 60, and a post 61. In an example such as that illustrated in FIG. 13, a thermal heating system 45 may be secured to a post mount bracket 60. The bust of the mannequin 1 may be secured atop the post-mount bracket 60 such that the thermal heating system 45 is disposed inside of the mannequin 1. Electrical wiring 52 may be routed from one or more components of the thermal heating system 45 through a hole 31 in a polyurethane shell 32 of mannequin 1. Electrical wiring 52 may terminate in an electrical connector 53, which may mate with a corresponding electrical connector and wiring leading to a power source, such as a battery or a wall outlet. In the embodiment of FIG. 13, a mannequin 1 may be easily replaced if eventually damaged from repeated impacts by ammunition or non-lethal weapons, and a thermal heating system 45 disposed on a post-mount bracket 60 may be able to be used with another mannequin 1. Other electrical or circuitry components (e.g., capacitors, resistors, a controller, and the like) may be included as needed. In an embodiment, more than one compact heaters 50 may be electrically coupled to the power source to provide thermal energy in a variety of locations in the mannequin. In an embodiment, a thermal heating system 45 may include a fan 40 to draw air through the heater 50 and circulate the air and disperse the thermal energy approximately evenly throughout the mannequin, providing a realistic external heat signature approximating that of a human.

In an embodiment, the wiring 52 may be routed out a separate hole 31 in the base of the bust of mannequin 1 and anchored with a strain relief 54. An example strain relief is depicted in FIG. 18. The wiring 52 may be brought out with the post-mount bracket 60 that the thermal heating system 45 may be mounted to. This would allow easier unit replacement in the field should all or part of a thermal heating system 45 get destroyed by a live round. This is depicted in FIG. 13.

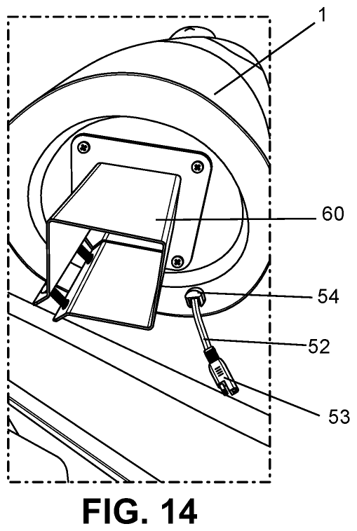

FIG. 14 illustrates the underside of a bust of the mannequin 1 depicted in FIG. 13 after the components have been assembled. A post-mount bracket 60 is depicted having been assembled to the bust of the mannequin 1. Thermal heating system 45 is disposed on the inside of the mannequin 1. Electrical wiring 52 is shown running from one or more components of the thermal heating system 45 in the inside of the mannequin 1 through a strain relief 54 and terminating in a connector 53.

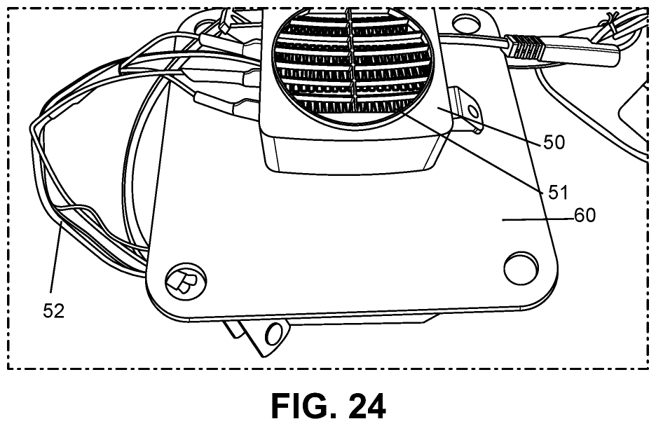

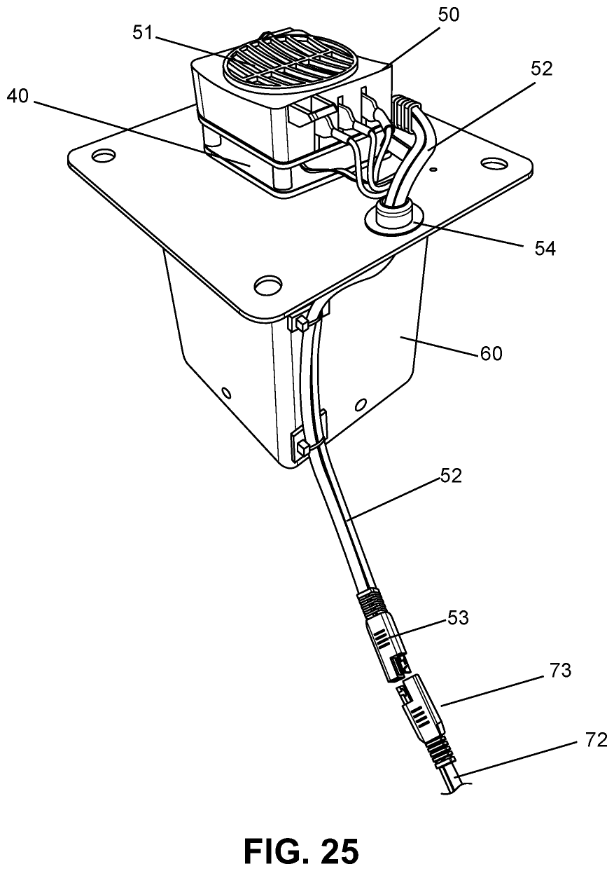

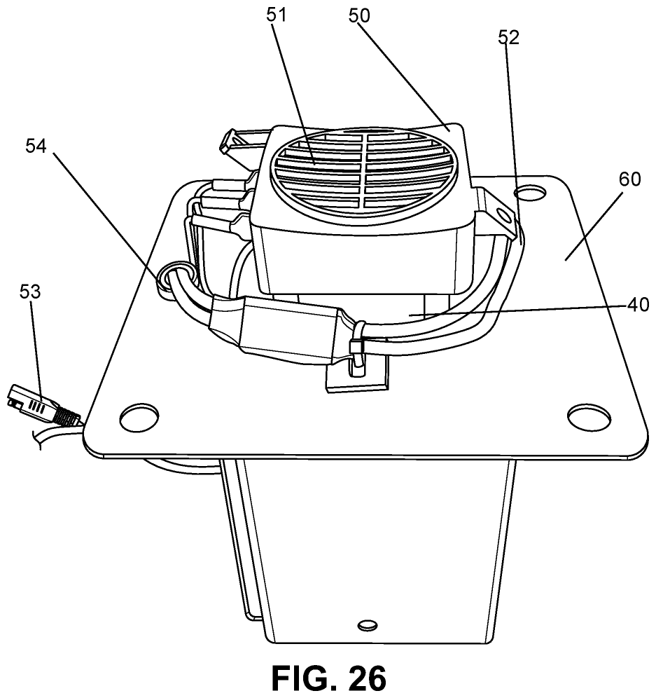

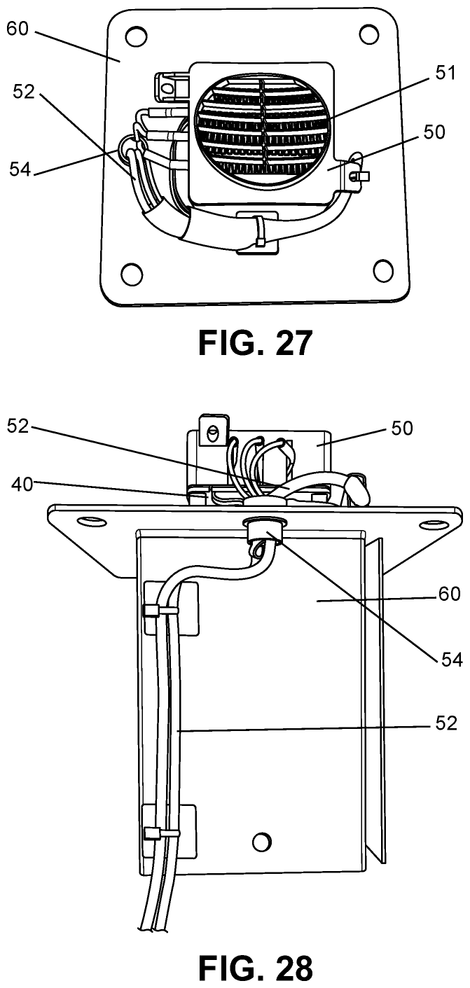

In an embodiment, a thermal heating system 45 may include a post mount bracket 60, a fan 40, a heater 50, heating elements 51, and associated electrical components, including electrical wiring 52, electrical connector 53, and strain relief 54. Electrical wiring 72 and corresponding connector 73 may lead to a power source. FIGS. 20-28 illustrate views of such an embodiment. In an embodiment, electrical wiring 52 to power components of thermal heating system 45 including the fan 40 and heater 50 may be routed through the post mount bracket 60. The electrical wiring 52 may be such that the electrical connection to the power source is located beyond the bottom of the post-mount bracket 60. One advantage according to this aspect of the disclosure is that an entire thermal heating system 45 may be replaced simply by removing one or more connectors (e.g., four screws), disconnecting the electrical connections from the power source, swapping out the thermal heating system 45, reconnecting the one or more connectors, and reconnecting the electrical connection(s) to the power source. In an aspect of the present disclosure, one or more portions of electrical wiring 52 and/or connectors 53 may be included in the thermal heating system 45 being swapped out.

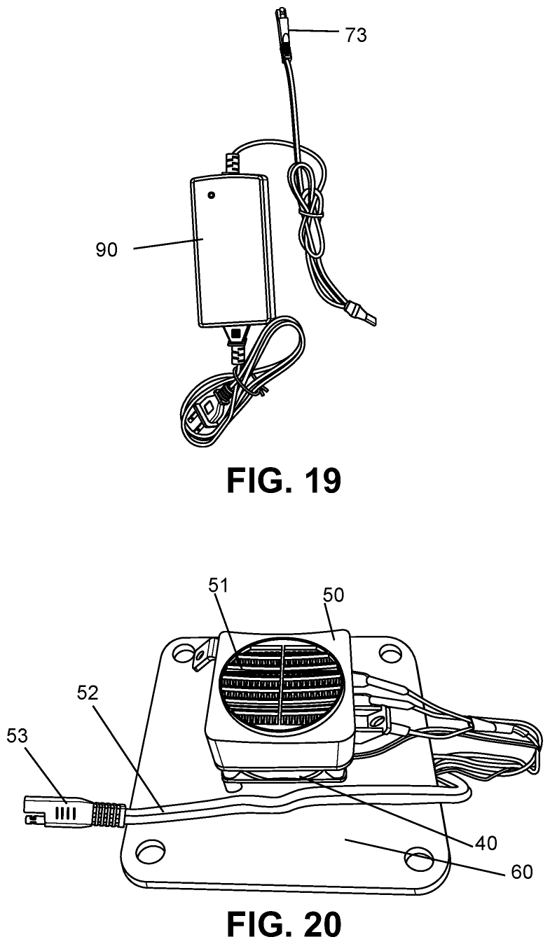

A bust of a mannequin 1 may include a 12 v, 10 A power block 90 (such as that depicted in FIG. 19) that connects with a standard 2 pin SAE plug electrical connector 73. Electrical connectors 53, 73 may be a 2-pin SAE plug. A user may attach a 2-pin SAE plug to a 12 v Deep Cycle Marine battery, an RV battery, or a small motorcycle battery for remote placement and use of the product using the same SAE plug.

Additionally, a remote (no convenient power) outdoor range could be equipped with a number of RV batteries maintained by a solar charging station, then plugged in to the electrical connector 53 for a thermal heating system 45 of a target mannequin 1 as training requires.

A thermal heating system 45 may be included in full-size mannequins, such as those depicted in FIGS. 1-9.

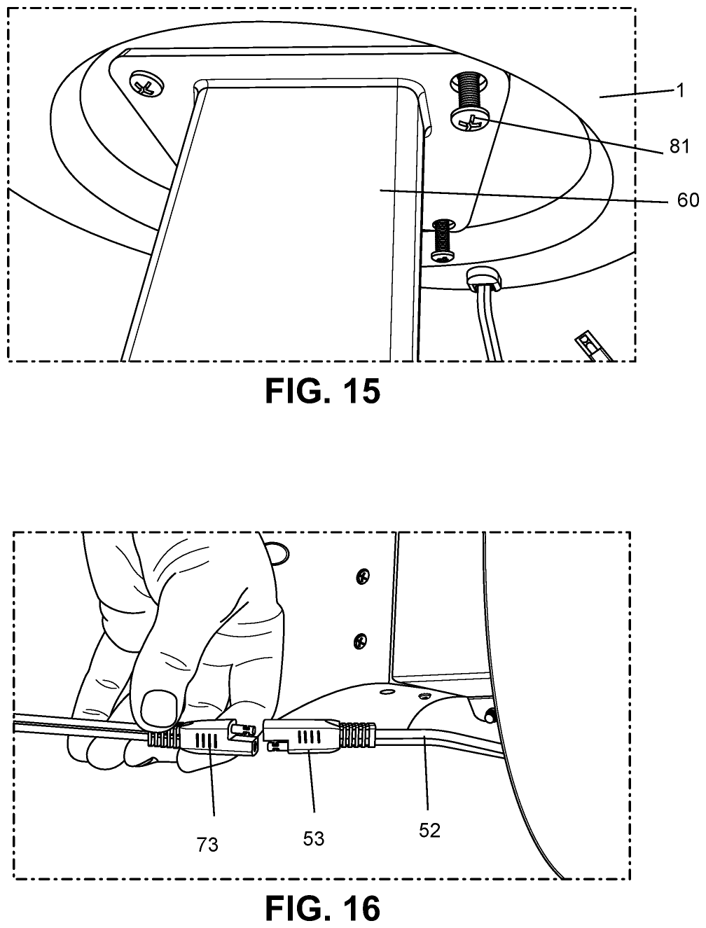

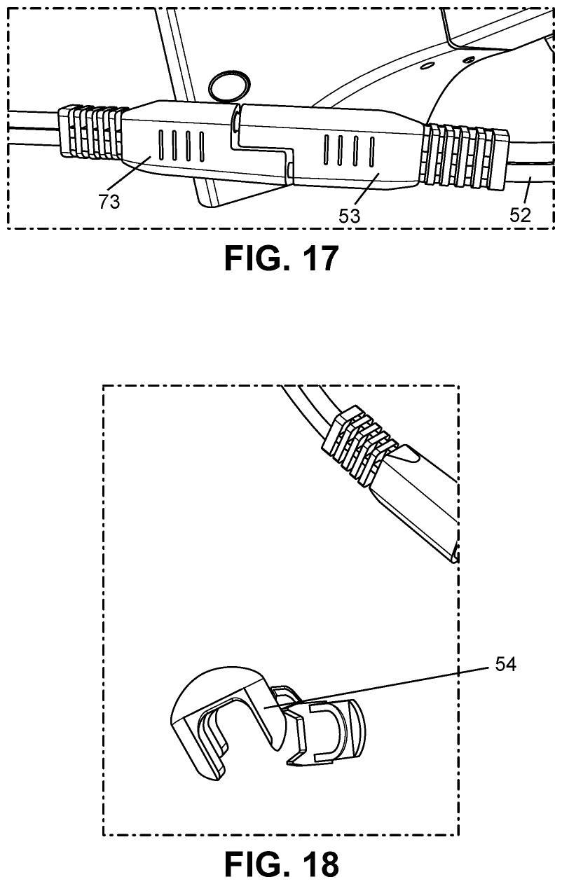

FIG. 15 illustrates how a post-mount bracket 60 may be attached to a mannequin 1 or part thereof (e.g., through a set of screws 81). FIG. 16 illustrates an electrical connection between an electrical connector 73 leading to a power source and an electrical connector 53 leading to a thermal heating system 45 (disposed inside of a mannequin 1) utilizing 2-pin SAE connectors. FIG. 17 illustrates a completed electrical connection as depicted in FIG. 16.

In an embodiment, at least one heater and a power source may be mounted to the inside of a mannequin. The heater may be mounted using brackets, screws, hook and loop fasteners, adhesives, or other means of mounting a heater to the inside of a mannequin. The heater and the power source may be electrically coupled. A button or switch for opening and closing the electrical circuit comprising the power source and the heater may be included and may be accessible from outside the mannequin for toggling on and off the heater (e.g., by opening and closing the circuit). In an embodiment, the power source is rechargeable. In an embodiment, an SAE two-pin connection may connect the power source to the heater.

In an embodiment, a thermal heating system may be powered through a wall (110-volt) outlet and may include voltage converters as necessary. FIG. 11 illustrates a power source extending through the shell of a mannequin into the interior of the mannequin or part thereof.

In an embodiment, the thermal heating system may include one or more heating elements extending across part or all of the interior of the mannequin. In an embodiment, such a thermal heating system may include wires, a mesh, or the like that are disposed about the interior of the mannequin in a substantially uniform manner. In an embodiment, such a thermal heating system may be electrically coupled to a power source such that, when the circuit is closed, the thermal heating system generates a relatively uniform heat across the mannequin to improve the uniformity of the simulated heat signature of the mannequin. A heating element may include a radiant heater or a convection heater. In an embodiment, a heating element may generate heat when a current flows through the heating element.

In an embodiment, a thermal heating system may radiate heat from about 80 degrees to 110 degrees Fahrenheit. In an embodiment, a thermal heating system may be configured to radiate heat from about 70 degrees to about 125 degrees Fahrenheit. In an embodiment, a thermal heating system may be configured to radiate heat from the mannequin at about 90 to 100 degrees Fahrenheit.

A mannequin including a thermal heating system may radiate heat in substantially the same manner (or having the same thermal signature as) a human. A mannequin having a thermal heating system may be useful as a target for nighttime training with thermal optics and/or other thermal gear. In an embodiment, a thermal heating system may be useful to simulate a human in a foggy or smoky environment (e.g., when simulating a rescue from a burning structure).

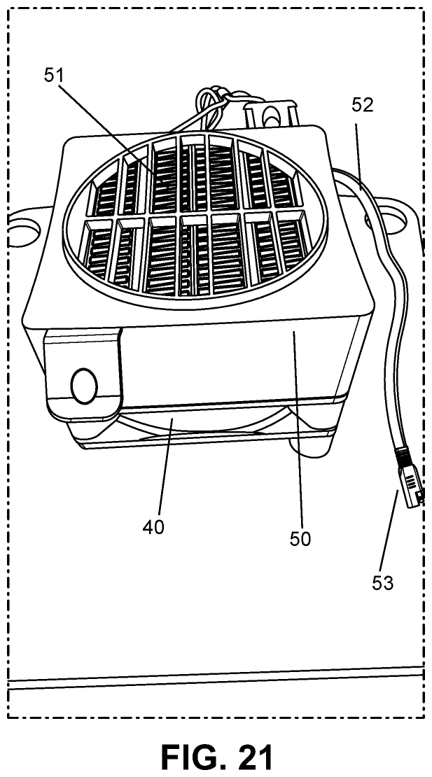

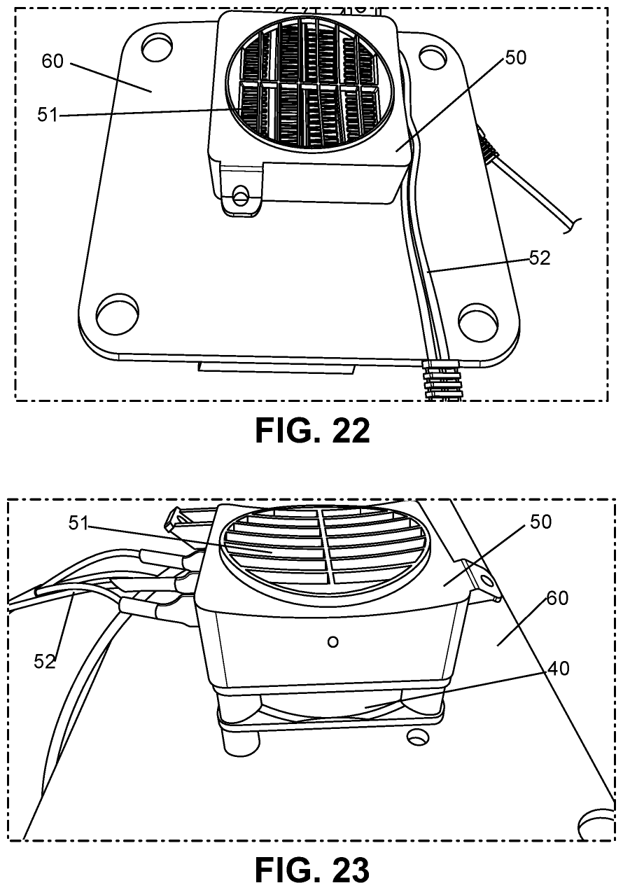

FIG. 20 illustrates an example thermal heating system 45 including, from bottom to top, a fan 40 (coupled to and disposed atop a post-mount bracket 60) coupled to a heater 50, and electrical connections to these components are also visible. FIG. 21 is an alternate view of FIG. 20, in which the fan 40 portion is visible atop the bracket 60 and below the heater 50. FIGS. 22-24 provide alternate views of an assembled thermal heating system 45, including dimensions of an example thermal heating system 45.

In another embodiment, one or more other characteristics of a human being may be disclosed. For example, a mannequin may include a speaker designed to emit breathing noises. In another aspect, a mannequin may include a speaker and/or a pressure generator designed to simulate a human heartbeat. One or more of these characteristics may be designed to make a mannequin detectable using one or more specialized tools, providing additional and alternative training scenarios.

While various aspects and embodiments have been disclosed herein, other aspects and embodiments will be apparent to those skilled in the art. the various aspects and embodiments disclosed herein are for purposes of illustration and are not intended to be limiting, with the true scope and spirit being indicated by the following claims.

1. A figure shaped as a human or human part, comprising:
a hollow shell configured to be sized and shaped like a human or a human part, the hollow shell comprising a thermosetting polymer and having an average thickness between about ⅕″ to about ½″;
wherein the thermosetting polymer, when cured, has sufficient hardness to withstand the impact of a rubber bullet, bean bag, pepperball, baton, stun gun, or stun-gun conductor without substantial amounts of chipping or cracking.

2. The figure of claim 1, wherein the hollow shell comprises a first layer and a second layer thermosetting polymer.

3. The figure of claim 2, wherein the first and second layers of thermosetting polymer are integrally bonded.

4. The figure of claim 3, wherein the integral bonding is formed by disposing the liquid thermosetting polymer of the second layer on the first layer before the first layer has completely cured.

5. The figure of claim 1, further comprising at least one weight coupled to the interior of the hollow shell.

6. The figure of claim 5, wherein the weight is located on the interior of the hollow shell on a position such that the hollow shell, when configured in an upright position, possesses a center of gravity similar to that of a human.

7. The figure of claim 5, comprising multiple weights coupled to and distributed throughout the interior of the hollow shell.

8. The figure of claim 1 1, further comprising arms and legs attached to shoulder and hip joints, respectively, wherein the shoulder and hip joints are rotatable and include magnetic attachments.

9. The figure of claim 1, further comprising a thermal heating system.

10. The figure of claim 9, wherein the thermal heating system includes at least one heating unit and a power source electrically connected to the heating unit, and wherein the heating unit and the power source are disposed within the hollow shell.

11. The figure of claim 10, wherein the heating unit and the power source are coupled to the interior of the hollow shell.

12. The figure of claim 10, further comprising a fan electrically coupled to the power source and disposed within the hollow shell.

13. The figure of claim 12, wherein the fan is configured to distribute thermal energy throughout the interior of the hollow shell.

14. The figure of claim 10, wherein the heating unit is configured to emit thermal energy such that the thermal energy radiating from the outside of the hollow shell, at equilibrium, is between about 70 degrees and 120 degrees Fahrenheit.

15. The figure of claim 14, wherein the heating unit is configured to emit thermal energy such that the thermal energy radiating from the outside of the hollow shell, at equilibrium, is about 95 degrees Fahrenheit.

16. The figure of claim 10, wherein the heating unit is a compact heater.

17. The figure of claim 14, wherein thermal energy radiates from the outside of the hollow shell such that the thermal signature mimics the thermal signature of a human.

18. A method of manufacturing a mannequin, comprising:
calculating a total amount of a polyurethane by weight to be added to a mannequin mold;
adding a first shot of between about 40% to about 50% of the calculated total amount of the polyurethane to the mold;
rotating the mold in a first rotating step at a temperature of between about 100 degrees Fahrenheit to about 120 degrees Fahrenheit;
adding a second shot comprising the reminder of the calculated total amount of polyurethane to the mold;
rotating the mold in a second rotating step at a temperature of between about 100 degrees Fahrenheit to about 120 degrees Fahrenheit; and
removing the molded polyurethane from the mold.

19. The method of claim 18, wherein the first rotating step continues for about five to about six minutes and wherein the second rotating step continues for about 30 to about 40 minutes.
